(19) United States
(12) Patent Application Publication
(10) Pub. No.: US 2017/0249581 A1
(43) Pub. Date: Aug. 31, 2017

(54) SYSTEM, METHOD AND PROCESS FOR DELIVERY OF A PACKAGE USING A TRUSTED ALTERNATE RECIPIENT NETWORK

(71) Applicant: BUURB, Jackson, WY (US)

(72) Inventors: Chris HENS, San Mateo, CA (US); Chris CONROY, Mt. View, CA (US)

(73) Assignee: BUURB, Jackson, WY (US)

(21) Appl. No.: 15/442,598

(22) Filed: Feb. 24, 2017

Related U.S. Application Data
(60) Provisional application No. 62/301,172, filed on Feb. 29, 2016.

(51) Int. Cl. G06Q 10/08; G06N 5/04; G06Q 10/04

(52) U.S. Cl. CPC G06Q 10/083; G06Q 10/047; G06N 5/04; H04L 63/0272

(57) ABSTRACT

The system, method and process enable a user to receive a delivery of a package and receive it in a timely fashion, securely through a network of trusted individuals (TARN), and obtain it without any damage to or loss of the item. The method and system is completed by securely integrating trusted users, neighbors and delivery companies in the same platform. The proposed intelligent trusted alternate recipient network design and methodology, also known as adaptive intelligence system introduces a new dimension to the delivery and cost optimization problem by providing real-time feedback to the delivery agents to relay the optimal delivery target. The data gathered by the delivery agents are fed back to the adaptive intelligence module for increasing the future accuracy of the candidate list based on GPS, user behavior, trend, ground realities and other inputs.

### CROSS REFERENCE TO RELATED APPLICATION

This application claims priority to Provisional application No. 62/301,172 filed on 29^{th} Feb. 2016. The pending U.S. Provisional Application No. 62/301,172 is hereby incorporated by reference in its entireties for all of its teachings.

### FIELD OF TECHNOLOGY

This disclosure relates generally to a method, process and system for creating and using a trusted network for accepting a delivery for the user from a delivering entity. More specifically a device that enables the user to use a method, process and system for intelligent package delivery minimizing loss of packages and cost of delivery.

### BACKGROUND

The existing delivery of packages to individual homes is done using email alerts from the delivery company or by tracking software provided by the delivery company with a window of six to 8 hours. If the package requires a signature, a receiver either has to be home and wait for the package or the delivery company must attempt delivery another time. If the product does not require signature, the delivery company may leave it at the door step. A lot of theft has been reported of such packages that are left at home. Additionally, perishable goods are at risk of getting spoiled.

There is a need for a dialogue process between the user and delivery company to conform to state laws, avoid losses due to theft, and to safely deliver packages to the receiver.

Delivery mechanisms presently do not use the complete data of user behavior, past history, GPS, and ground reality to derive an optimized assignment pattern and delivery. Backend intelligence does not either collect data or use data available for analyzing the customer acceptance patterns and their choice of acceptable alternates.

Delivery mechanisms presently depend on moving the package back to the depot at the end of the day for it to be redistributed another day or requires the customer to travel to pick it up. Both options are suboptimal and expensive.

Delivery companies do not maintain a candidate list for alternate delivery options even for their premium users. It is still an archaic process whereby a manual intervention is necessary for every delivery. Delivery mechanisms have room for optimization due to advent of automation. With every advance, such as drones, new challenges arise for reliable and safe delivery. There is a need for a more effective delivery mechanism by managing the delivery and safe receipt of the packages.

### SUMMARY

Several embodiments for a system, method and process for a delivery of a package using a trusted alternate recipient network on a device are disclosed. The proposed system, process and method enables the users with a computer or mobile device to establish a safe network with their neighbors and friends in a secure environment and the delivery company to access that information in real time to deliver the package. In one embodiment, the system, process and method after establishing a secure environment with their trusted group provides for the user to communicate, share and publish their network for a package delivery to the delivery company with a chosen trusted user who happens to be a neighbor. This disclosure relates to a method for intelligent assignment and transportation of packages and optimizing delivery in the first run.

In another embodiment, when a delivery is in progress, the system, method and process provides the driver of the delivery company on his device with current information about the availability of a delivery recipient who needs to either sign or not sign for the package delivery. The system, method and process embedded in the mobile device using the processor or hardware first determines if the customer/user is available to sign for delivery. If not, the application on the mobile device automatically reaches out to the user network and updates the driver's route to that of a trusted neighbor (alternate recipient) who has indicated they are currently available. The goal is “first attempt delivery.”

In one embodiment, using any mobile device, hardware that can house this application for a user, delivery company and a trusted neighbor to create a closed loop network with highest security.

In another embodiment, the user may inform the delivery company about his availability for the delivery day and if something changes he may connect with the driver or the delivery company on the system platform and schedule an alternative trusted neighbor location and recipient.

In another embodiment, a system platform maintains options for several trusted neighbors as back-up for each user's delivery request and once a shipment has been initiated, and one trusted neighbor has confirmed, the message is delivered to the delivery company and the recipient address is modified.

In another embodiment, the recipient address is updated in the delivery company backend systems and then delivered to the driver's handheld device. This allows the flexibility of delivery to any of the members in alternate recipient list.

In another embodiment, once the trusted neighbor has confirmed availability to receive the delivery for a user and subsequently becomes unavailable prior to delivery, the delivery company may look up user preference and may query the system for availability of an alternate person, which may include the original user or alternate trusted neighbor. However, a time limit or other constraint may impact the delivery company's scheduling of their routes.

In another embodiment, when a user notifies the system that they are unavailable to receive the package, the system automatically and adaptively identifies an available alternate recipient.

The application as a method and system may be implemented on the delivery company servers and platform including handheld devices. Users may be added to their list and the maps for the trusted neighbor may be populated using data from their systems or knowledge bases. The delivery company may also suggest a trusted neighbor to a user if the physical proximity of the trusted neighbor is close to the user. This would create awareness and an increase in sales for the delivery company. A delivery company may be just a delivery company or a business that has sold the product to the user.

In another embodiment, by accepting delivery, trusted neighbors receive cash, credits and delivery discounts that are automatically accrued and stored in their account and the system notifies them of their accumulated credit.

In another embodiment, a trusted Hub Neighbor has made a business of accepting deliveries for neighbors. Hub Neighbors are qualified and certified and will facilitate “first attempt delivery” for a broad range of overstocked storage facilities and provide for package depot services users in proximity to the final delivery recipient.

The trusted neighbor network will grow across industries and be able to offer cross-marketing opportunities. The users who join because they have to sign for a weekly food service delivery, for example, may also like wine. The proposed invention does not preclude a typical vertical marketing opportunity, instead can be used for other industries as well. The delivery is not precluded to a package or box, but can be a real-time perishable food, groceries, and other items. For example, in one embodiment, the invention can be applied as a superset for controlling the delivery network such as Uber food and Amazon for finding alternate cohort sets of recipients. The trusted neighbor networks will grow across geographies and industries, creating community-based marketplaces and offering marketing opportunities to merchants, delivery companies and parcel carriers.

The backend intelligence system may be implemented on a cloud-based centralized platform so that delivery agents, both manual and automated, can be managed in various cities, states, provinces and countries.

In one embodiment, the backend intelligence obtains the GPS and the customer information from the delivery agents and calculates the candidate list of people that can accept the delivery on behalf of the customer in case the customer is absent to receive the package.

In another embodiment, the base case of allowing a user to configure set neighbors in a preferential order for delivery as part of the initial cohort entries is made possible. This does not preclude backend intelligence to add additional entries to the cohort list with the configured few names by users as the initial entries. There may also be a provision to add manual selection from the user to pick their own network and if it is out of the range for the delivery company they may request for an additional delivery fees and deliver it to a safe location.

In another embodiment, the backend intelligence calculates the optimal candidate list using adaptive intelligence, historical data, analytical computations or predictive models based on GPS, user past behavior, historical, ground reality, and/or trend data.

In another embodiment, the intelligent trusted alternate recipient network design and methodology, also known as proposed process, method and system has a real-time or near-real-time dialog with the end customer to communicate their preferred alternate delivery recipient from the candidate list, so the package can be delivered safely.

In another embodiment, the delivery agents provide feedback to the backend intelligence for data mining and analyzing it for future predictions, trends and reporting.

In one embodiment, the adaptive intelligence will use numerous inputs to derive the optimal alternative delivery recipient from the list of trusted neighbors. Analysis of hysteresis in the communication with these neighbors, with higher weighting for rapid response, for example will increase the ranking of the neighbor within the system selection process. In one embodiment, hysteresis can be applied on the communication lag time as part of the selection process, namely if someone takes too long to respond, they may be the last to be consulted for availability. In another embodiment, hysteresis can be applied on the number of times a candidate has proxies for a user. In another embodiment, distance from the target can be applied. For example, distance from the original target recipient will drive the ranking lower. User preference will push it higher, etc.

In another embodiment, the data derived and obtained are stored as part of user knowledgebase that can be accessed by experts. In one embodiment, real-time or near-real-time data analysis is conducted enabling the delivery agents to benefit by continuing their operations without delays.

The system, method and process disclosed herein may be implemented by any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

Delivery company handheld devices may be updated with new information about the status of the recipient in real time and enables the delivery personnel to view the information for an updated address. Also the system and method enables the handheld device to receive updates on optimal route and delivery address on a real time basis using the back end intelligence server. The disclosed method, system herein may be implemented in any means for achieving various aspects. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a block diagram of an example of an instant system of the proposed intelligent trusted alternate recipient network design and methodology, also known as BUURB 100, according to one or more embodiments.

FIG. 2 is a block diagram illustrating the different modules within an instant system application 200.

FIG. 3 illustrates various delivery mechanisms to handover the packages and parcels to customers or alternate recipients.

FIG. 4 shows different communication mechanisms used by the delivery entity to communicate data.

FIG. 5 depicts the high level architecture of the intelligent trusted alternate recipient network design and methodology, also known as BUURB system and the delivery of a package using a trusted alternate recipient network.

FIG. 6 illustrates the end to end delivery architecture from a delivery agent to customer, and the delivery agent to decision making backend intelligence engine.

FIG. 7 shows the end to end communication architecture used by manual delivery agents and the drone delivery agents for sending messages between them and to the back end intelligence engine.

FIG. 8 illustrates the method, system and process of the front end delivery agent of an instant novel application system shown as BUURB and intelligent trusted alternate recipient network design and methodology, also known as BUURB.

FIG. 9 shows the controller architecture of the front end delivery agent of an instant novel application system shown as BUURB and intelligent trusted alternate recipient network design and methodology.

FIG. 10 illustrates the overall intelligent trusted alternate recipient network design and methodology, also known as BUURB system, including cloud based intelligent trusted alternate recipient network engine, and its dependencies to the delivery agents.

FIG. 11 shows the adaptive intelligence modules of the intelligent trusted alternate recipient network design and methodology, also known as BUURB adaptive intelligence modules that provides the main computation engine and management.

FIG. 12 illustrates the control and the data flow in the application of intelligent trusted alternate recipient network design and methodology, also known as BUURB application system between the delivery agent and the backend adaptive intelligence module.

FIG. 13 shows the message sequence diagram illustrating application controller of the intelligent trusted alternate recipient network design and methodology, also known as BUURB application controller interactions for delivery.

FIG. 14 illustrates the message sequence diagram illustrating the intelligent trusted alternate recipient network design and methodology, also known as BUURB adaptive intelligence mechanism.

FIG. 15 provides the problem statement on the need for an application system such as intelligent trusted alternate recipient network design and methodology, also known as BUURB.

FIG. 16 shows the intelligent trusted alternate recipient network design and methodology, also known as BUURB application user interface coordinating the delivery to either customer or an alternate recipient.

FIG. 17 show the shopping cart of the application with some of its menu items.

Other features of the present embodiments will be apparent from the accompanying drawings and from the detailed description that follows.

### DETAILED DESCRIPTION

Several systems, methods and process for creating and using a trusted network for accepting a delivery for the user from a delivering entity are disclosed. Although the present embodiments have been described with reference to specific example embodiments, it will be evident that various modifications and changes may be made to these embodiments without departing from the broader spirit and scope of the various embodiments. This disclosure also relates to a comprehensive methodology of using a trusted network by creating trusted recipient network. The methodology is used for identifying personal, geographical proximity, acquires delivery information, receiving time from vendor through the process, system and method and to receive a delivery safely in a timely manner. This disclosure also relates to a comprehensive methodology for building a trusted neighbor network through the combination of user personal preferences and analysis of geographical proximity, acquired delivery information from carriers, acquired delivery company route algorithms, Hub Neighbor capability and performance data, merchant and delivery company preferences and other related package delivery information for the purpose of ensuring secure, first attempt delivery of packages.

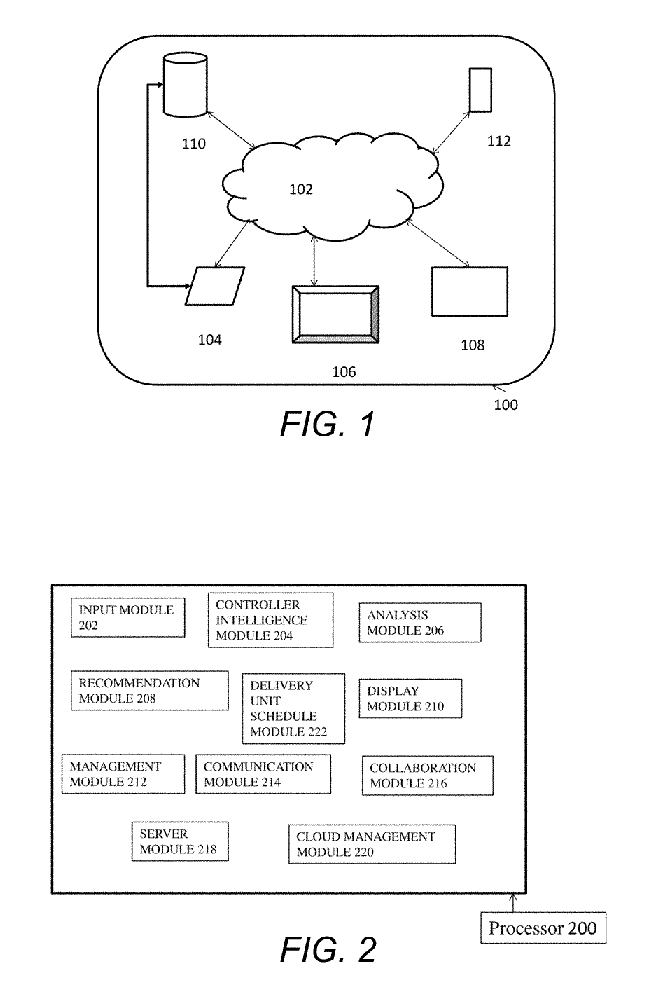

FIG. 1 is a block diagram of an example of an instant system (BUURB) 100, according to one or more embodiments. Particularly, the instant system is supported by server 104, computing devices 106, 104, 108, and 102 (some, computer such as 106, cellphone or other mobile device 112, ipad or handheld device 104, any display device 108), a network 102. A network 102 may be a local area network (LAN), wide area network (WAN), metropolitan area network (MAN), extranet, intranet, internet, peer-to-peer network or the like or a combination thereof. In the case of a wireless network, 102 may comprise, but need not be limited to HomeRF, HiperLAN, Bluetooth, Zigbee, WiMAX, Wibree, FM, AM, 802.11 (G, N), WiFi and satellite, Wireless ISP, Satellite Broadband, Mobile Broadband, Local Multipoint Distribution Service and satellite communication systems etc. In one embodiment, the instant system may be a server-client system with processing occurring on one or more computers or mobile devices connected through a network 102. In another embodiment, the instant system may be a peer-to-peer system with processing occurring in all computers or mobile devices connected through a network 102. In one embodiment, data is aggregated and stored in a central database server connected to one or more computers or servers either directly or through a network 102. In another embodiment, data stores may be distributed among various devices and servers in the instant system.

FIG. 2 is a block diagram illustrating the different modules within the instant system (BUURB) application on a processor 200. Input Module 202 may receive inputs from other systems within or external to the instant system, and from users. Controller intelligence module 204 may contain system templates and may request data from other modules within the instant system (BUURB) application to create associations among data using system templates. Analysis Module 206 may receive data from other modules and process that data to generate individual or aggregated route/direction metrics. Recommendation Module 208 may calculate the preferred route or suggest next best trusted neighbor. Display Module 210 may present a user interface to a user to visually display results generated by the instant system (BUURB) application. The display user interface may be interactive allowing the user to view, add, edit, configure, copy, store, remove, send or comment upon displayed results. The display module will also allow the delivery company or the delivery person to view, record and schedule information pertinent to delivery of the package.

One or more Input Module 202 may receive data through integrations with other systems or through manual inputs. The Input Module may automatically pull content and associated meta data from multiple sources, including but not limited to, a user's contacts, calendar, email, phone logs and other individual accounts. This data may be used by the system to analyze how, with whom and for what general purpose the user is spending his purchasing trends.

In one embodiment, the architecture shows a controller intelligence module 204 which is either part of the group or a general user who is connected to the delivery company. In one embodiment, the recommendation module 208 is shown to enable the functionality to communicate between a delivery agent schedule module 222 and several consumer/user intelligence modules. In one embodiment, the delivery agent schedule module 222 is connected to the consumer/user intelligence controller intelligence module 204 through Internet 102 via a LAN or a Wireless LAN or a cellular network using 2G/3G/LTE 101 using WiFi routers. The recommendation module 208, communicates between the two clients, namely delivery schedule module 222 and consumer/user controller intelligence module 204, analyzes the delivery options and communicates the result to the delivery schedule module. The redundant information database module 212 uses the redundant user knowledgebase 310 for authentication purposes. The redundancy provides the required fault tolerance. Similarly, the recommendation module 208 uses the redundant information database 312 for digital object purposes. The communication module 214 provides the capability to transfer or receive information between the delivery agents and the backend intelligence. Cloud management module 220 provides the capability to manage the backend intelligence over cloud (Internet). The intelligence need not reside at the delivery agent. Server module 218 provides the knowledge base capability in the backend to work with the intelligence module 204.

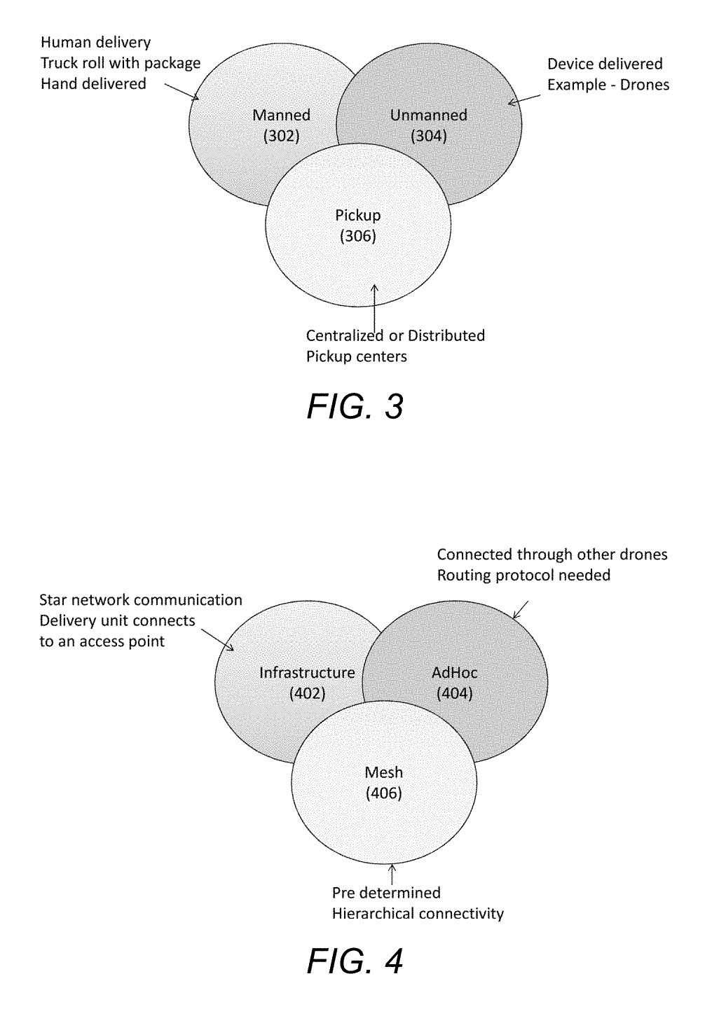

FIG. 3 illustrates the three modes of delivery mechanisms for the parcel/package delivery using trusted alternate recipient network application system, method and process on a device. The delivery can be a manned delivery 302, or an unmanned delivery 304, or a pickup location 306. The management module 212 would enable a user and the delivery company or delivery person or a mechanical device that is remotely controlled by the delivery company to communicate using the communication module 214 in the processor 200 or a platform or a back end server.

Manned delivery mechanism 302 expects a human with a manual delivery agent to reach the package destination to deliver the package to the user/customer. This requires a mode of transport, in general without loss of generality would be a truck/vehicle roll. The package is hand delivered to the customer today. The presented invention proposes a way to find trusted alternate recipient where the package can be efficiently and inexpensively delivered if the customer is unavailable to receive the package delivery.

Unmanned delivery mechanism 304 expects a non-human automated device such as Unmanned Aerial Vehicle (UAV), drone or an automated vehicle such as self-driving vehicle, with a drone delivery agent to deliver the package with no or partial human intervention. The mechanism requires delivery to the customer or an acceptable alternate delivery recipient when a customer is absent to receive the delivery

Pickup mechanism 306 expects the customer to visit a location, either end point or intermediate (such as post office) to receive the package sent. The locations can be either centralized or distributed pickup centers.

FIG. 4 illustrates the three different communication mechanisms following the part of communication module 214 used by the manned 302 and unmanned 304 delivery agents to use to communicate with the back end intelligence to determine important information about the customer, route to be taken and accounting details. The communication is conducted using communication module 214, collaboration module 216 in case of change in delivery destination or time. All this data can be managed by using server module 218 and/or cloud management module 220.

Manned delivery agents 302 may use infrastructure mechanism to communicate with the backend intelligence module. In that case, Infrastructure 402 mode of communication uses star network topology, where every delivery agent is associated with an access point. In one embodiment, WiFi is an infrastructure 402 mode of communication, where a delivery agent is the access client communicating with an access point which has backend connectivity to Internet 102. In another embodiment, WiMAX can be used as an infrastructure 402 mode of communication. In another embodiment, LTE can be used as an infrastructure 402 mode of communication. The manned delivery in general can use either wired or wireless communication to reach backend intelligence over private or public network including Internet. In one embodiment, similarly an unmanned delivery agent 304 can use an infrastructure mode 402 of communication to reach backend if it uses a centralized access point to reach backend intelligence. Without loss of generality, an unmanned delivery agent 304 may use WiFi, WiMAX, LTE or any other technology that works in infrastructure mode 402 to reach the backend intelligence.

Unmanned delivery agents 304 may use Adhoc 404 mechanism to communicate to the backend intelligence, if they go through other delivery agents rather than an access point. In another embodiment, similarly a manned delivery agent 302 may use Adhoc 404 mechanism to communicate if it uses other manned or unmanned delivery agents to reach the backend intelligence without going through a centralized access point. It is imperative that every delivery agent that uses Adhoc 404 mechanism knows a way to forward or route the packages to the backend intelligence through other delivery agents based on its forwarding and/or routing table.

In another embodiment, manned delivery agent 302 or unmanned delivery agent 304 may use mesh networking 406, where a tree structure topology is used to network various delivery agents with predetermined forwarding hierarchical rules. The delivery agents can be in any of the form factor including hand held devices, smart phones, tablet, fablet, laptop or customized device with display.

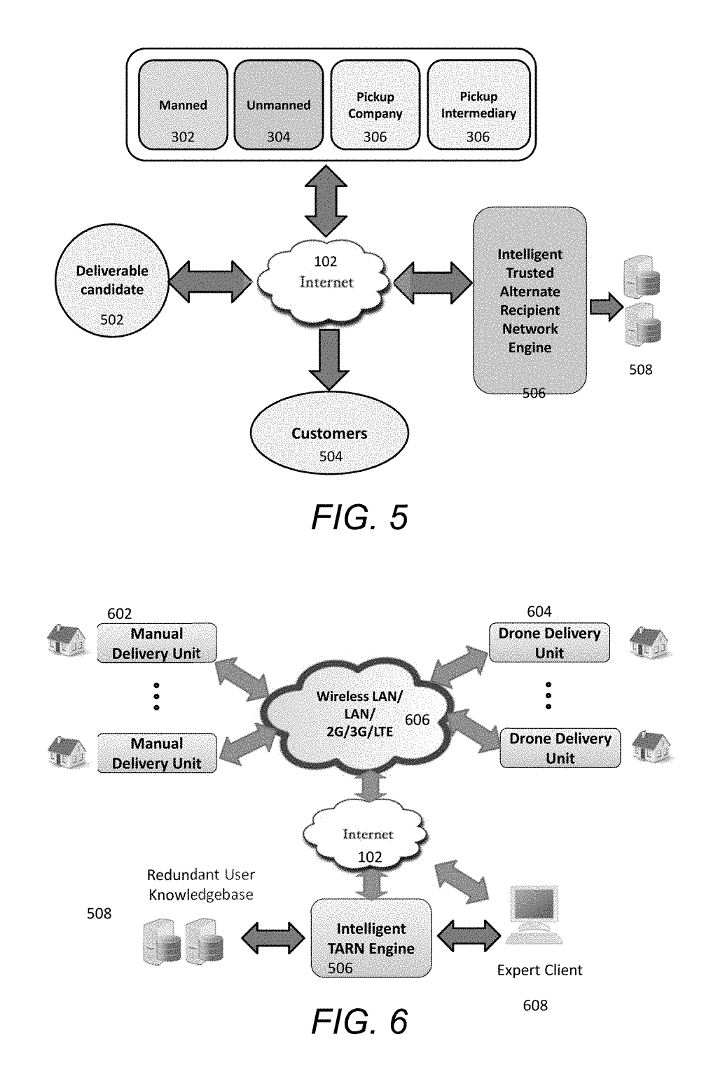

FIG. 5 illustrates the high level architecture of the proposed application system of intelligent trusted alternate recipient network design and methodology, also known as BUURB application system. In one embodiment, the delivery mechanism is manned in nature with human intervention 302. In another embodiment, the delivery mechanism is unmanned 304 using UAV and drones etc. In another embodiment, the delivery mechanism is to have a centralized repository for customers to pick up company 306. In yet another embodiment, pickup intermediaries such as post office or mail box or hired folks can be used for delivering packages to customers 306.

The delivery mechanisms use Internet 102 to communicate with the backend intelligence, namely intelligent trusted alternate recipient network engine 506. The backend intelligence 506 uses the user knowledgebase 508 redundant system to store all the information related to intelligent trusted alternate recipient network design and methodology, also known as BUURB system. The knowledgebase resides as part of a server module 218. In one embodiment manned 302 and/or unmanned 304 delivery agents can use either infrastructure 402, adHoc 404 or mesh 406 communication mechanisms to reach the backend intelligence 506 over Internet 102.

Backend intelligence 506 using the user information in database 508 and proposed intelligent trusted alternate recipient network (TARN) engine, design and methodology alternate recipient determination mechanism in intelligence TARN engine 506 provides the candidate list of alternate recipients deliverable candidate 502 that the delivery agent can target if the customer 504 is unavailable to receive the packages personally. In one embodiment, user interface of the intelligent trusted alternate recipient network design and methodology contacts the customer through SMS, text messaging, email, chat, VoIP, and other voice, video and data mechanism to suggest the candidate list and agree on an alternate recipient deliverable cohort where the package can be delivered. In one embodiment, the customer can choose to exercise an exception and not select any alternate recipient deliverable and request the package be left in front of the home signing a waiver. In another embodiment, the customer may choose to have the package taken back to the pickup repository 306.

FIG. 6 illustrates the end to end delivery architecture of the proposed intelligent trusted alternate recipient network design and methodology. In one embodiment, the delivery is done by manual delivery agents 602. In another embodiment, the delivery is done by drone delivery agents 604. In another embodiment, the delivery can be done by a combination of manual delivery agents 602 and drone delivery agent 604.

In one embodiment, the delivery agents 602, 604 may use infrastructure mode of communication 402. In another embodiment, the delivery agents 602 and 604 may use adHoc mode 404 of communication. In another embodiment, the delivery agents 602 and 604 may use mesh mode 406 of communication. In another embodiment, the delivery agents 602 and 604 may use a hybrid combination of infrastructure 402, adHoc 404 and Mesh 406 modes of communication to communicate with the backend intelligence 506 over Internet 102102.

Backend intelligent Trusted Alternate Recipient Network (TARN) Engine 506 communicates with redundant user knowledgebase 508 to obtain user information. In one embodiment, the system also provides the intelligent engine 506 to be accessed by an expert client 608 for management and learning purposes either directly or over Internet 510. The expert client 608 for management becomes part of the management module 212. The intelligent TARN engine 506 resides in the cloud 220 and is managed through Internet. Hence it is location invariant.

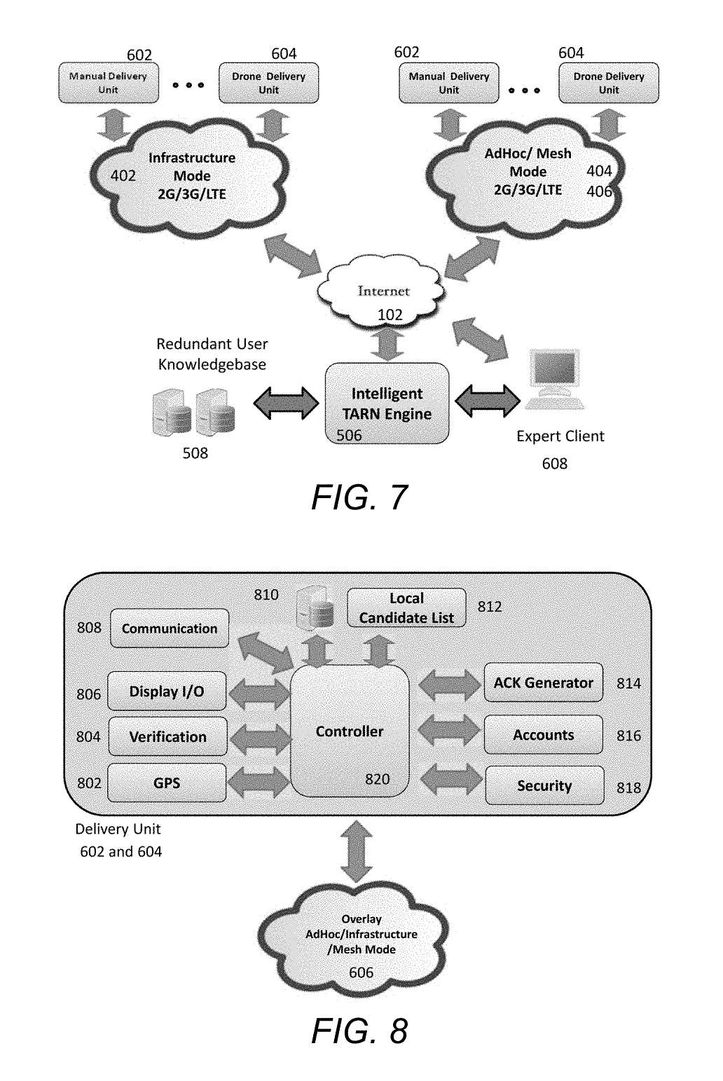

FIG. 7 provides the end to end communication architecture of the proposed trusted alternate recipient BUURB system.intelligent TRAN design and methodology. In one embodiment, the system has a combination of manual delivery agents 602 and drone delivery agents 604 using Infrastructure 402 mode, Adhoc 404 and Mesh mode 406 of communication to reach the intelligent TARN engine 506 over Internet 102. The infrastructure mode 402 can be 2G, 3G, 4G, or 5G technology and without loss of generality is applicable for all past, present and future technologies that use a centralized mechanism of communication. In another embodiment, the adhoc 404, mesh mode 406 can be 2G, 3G, 4G, or 5G technology and without loss of generality is applicable for all past, present and future technologies that use distributed mechanism of communication where information is forwarded and/or routed through other delivery agents.

FIG. 8 illustrates the proposed application of intelligent trusted alternate recipient network design and methodology delivery agent architecture. In one embodiment, the delivery agent can be manual delivery agent 602 and in another embodiment, the delivery agent can be drone delivery agent 604. The system modules for both manual 602 and drone 604 units are same. Internal implementations of the modules may differ. The delivery agent consists of GPS module 802, Verification module 804, Display I/O module 806, Communication module 808, local database 810, local candidate list 812 that provides a list of trusted alternate recipients that are locally stored in the delivery agent, acknowledgment generator 814, accounts module 816, security module 818 and the controller 820. The controller 820 may be considered as the heart of the proposed application of intelligent trusted alternate recipient network design and methodology.

GPS module 802 provides the GPS coordinates of the delivery agent and the information of the alternate recipient's, candidates and customer's GPS coordinates. Verification module 804 provides the end customer verification functionality before delivering the package. In one embodiment, the verification is visual such as photograph. In another embodiment, the verification can be approved user identification such as passport, driver's license or health card. In another embodiment, verification could be biometric such as retinal scan or thumb/finger prints. In another embodiment, verification could be a signature. In another embodiment, when a user has a session with delivery agent to discuss candidate list, verification module 804 may use a mechanism such as Captcha, OAuth, OAuth2 or chat password or questionnaire to authenticate.

Display I/O module 806 provides the input/output mechanism for the application of the intelligent trusted alternate recipient network design and methodology, also known as BUURB application GUI. Communication module 808 deals with the method of communication between the delivery agent 602, 604 and the back end intelligence over Internet using Infrastructure 402, AdHoc 404 or Mesh 406 mechanisms. Local database 810 provides the cache and storage for delivery agent application modules. Local candidate list 812 provides the data structure needed to maintain the candidate list for the customers in the delivery agent route. Acknowledgement (ACK) generator 814 module provides the acknowledgement of having delivered the package to a customer or alternate recipient. Accounts module 816 provides the customer account information if anything to be charged. Security module 818 is used for authentication of the delivery agent 602, 604 to the backend intelligence. The communication of the information happens on top of the base network (such as 2G/3G/4G/LTE/Fiber/Satellite) using a protocol that uses infrastructure or adhoc or mesh mode 606. Adhoc/Infrastructure/Mesh mode wireless network 606 will be an overlay network over the base network.

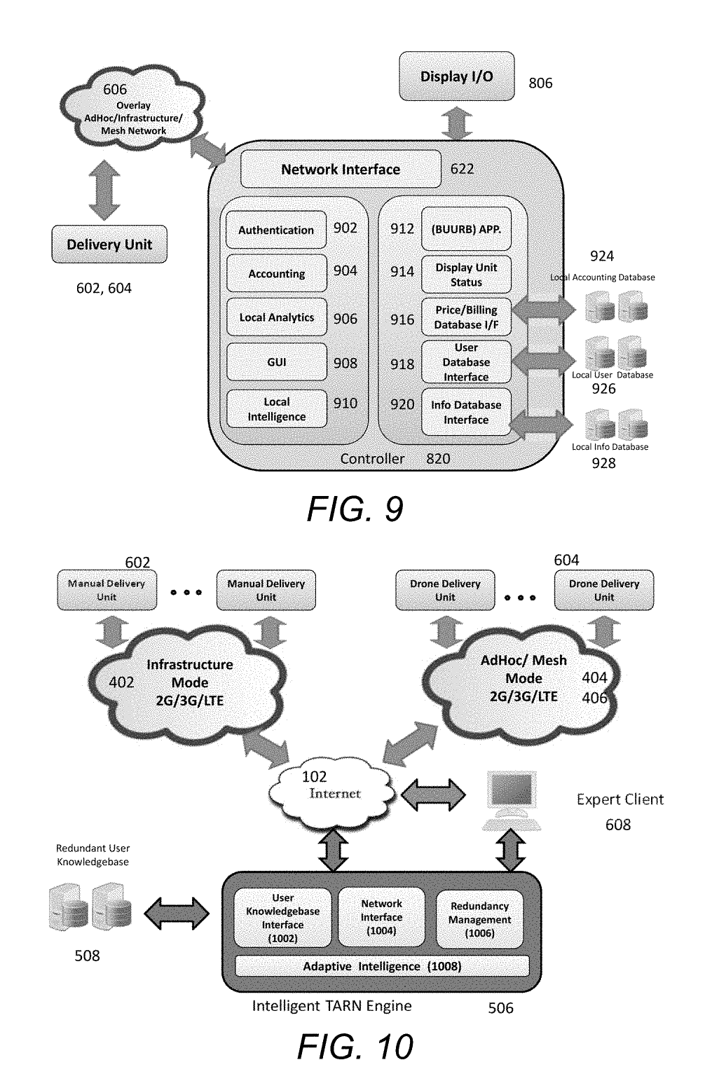

FIG. 9 illustrates the controller 820 architecture within the proposed intelligent trusted alternate recipient network design and methodology, also known as BUURB system delivery agent. The controller 820 uses the network interface 622 to communicate with backend intelligence using one of the communication mechanisms 606. This could be through other delivery agents 602, 604. Controller 820 provides information to be displayed in the unit via Display I/O 806. Controller interfaces with local info database 928, local user database 926 and local accounting database 924. Local info database 928 contains information pertaining to the system, Local user database 926 contains information related to the customers and alternate recipients in that particular run of delivery. Local accounting database 924 is a secure storage for all customer related payment information.

Authentication module 902 provides the functionality of verifying the customer, alternate recipient and the backend intelligence through various security features. In one embodiment, the backend connectivity could be a secure VPN based connection set up from the delivery agent by controller 820 all the way to the backend intelligence with unique authentication keys. In another embodiment, the authentication could be via user name and password.

Accounting module 904 provides the functionality of customer and delivery agent accounting. It has the information about customer accounts and interfaces with the accounting information in the database 924. In addition, it interfaces with price/billing to create invoices and receipts. Local analytics module 906 provides the functionality of collecting user (customer and alternate delivery recipient) data. It also collects information about delivery agent travel data. It collects user behavior data and transfers to the backend intelligence module. It is one of the main interfaces to obtain usage data on which adaptive intelligence algorithms can be applied to deduce important user statistics.

GUI module 908 is part of the application of intelligent trusted alternate recipient network design and methodology, also known as the BUURB application, that provides through display I/O 806 user interface experience to the customer at delivery agent. Local intelligence module 910 provides the decisions for selection of alternate recipient from candidate list based on availability and proximity and other factors. Intelligent trusted alternate recipient network design and methodology, also known as BUURB App 912 is the main hosting application for the proposed system. The application provides the user experience, content management and interactions. Application of intelligent trusted alternate recipient network design and methodology, also known as BUURB app 912 interacts with customer over voice, video or data to obtain permission to deliver the package to a member of their TARN. In one embodiment BUURB app 912 could use chat sessions with customers to discuss the candidate lists. In another embodiment BUURB app 912 may use voice calls to authenticate and discuss the candidate lists.

Display unit status 914 module manages the stability of the delivery agent. Price/Billing database interface module 916 provides the link to the database for the accounting module 904 to access the data. User database interface 918 provides the link to the database for the authentication module 902 and local analytics 906. Info database interface 920 provides the interface for local intelligence 910 to collect, store and deliver data.

FIG. 10 provides the cloud based intelligent TARN engine architecture. In one embodiment, the Intelligent TARN engine 506 provides the adaptive intelligence to the delivery agent's behavior of whom to turn to in the case of the customer's absence. In another embodiment, intelligent TARN engine 506 provides the management of all manual and drone delivery agents from a centralized location to utilize the TARN for proper delivery of packages. All delivery agents, Manual 602 or drone 604, interacts with the centralized intelligent TARN engine 506 for their proper directions. The request is sent via Internet 510 and hence Intelligent TARN engine 506 is a cloud based entity that can truly reside anywhere as long as there is connectivity to it. Expert clients 608 have direct access to Intelligent TARN engine 506 or access through Internet 510. NOC administrators can directly login through expert client 608 to maintain the backend intelligence engine 506. Redundant user knowledgebase 508 is interfaced directly to the intelligent TARN engine 506. The knowledgebase 508 contains the master information base to conduct heuristics and other analytical calculations adaptively to come up with the best candidate list based on GPS, ground reality, past user behavior and other inputs.

Intelligent TARN engine 506 has the user knowledgebase interface 1002 that executes the Application Programming Interface (APIs) to access the user knowledgebase 508. Redundant management 1006 manages the fault tolerance and reliability of the user knowledgebase 508. Network interface 1004 provides the connectivity to the network to manage the delivery agents 602, 604. BUURB—Adaptive Intelligence 1008 is the heart of the Intelligent TARN engine 506 providing the main adaptive intelligence based on predictive models conducted on user behavior, GPS, ground reality, history and trend.

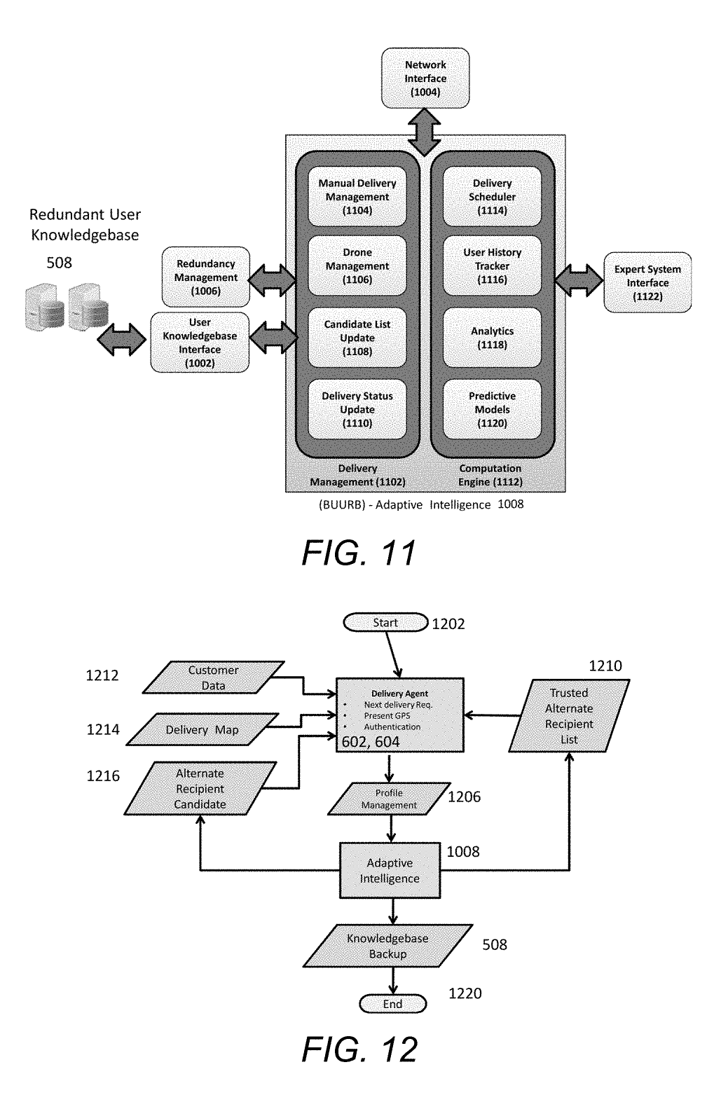

FIG. 11 illustrates the adaptive intelligence of the intelligent trusted alternate recipient network design and methodology, also known as BUURB adaptive intelligence module dependencies 1008 on the other modules such as user knowledgebase 1002, redundancy management 1006, expert system interface 1122 and network interface 1004. Intelligent trusted alternate recipient network design and methodology, adaptive intelligence 1008 has two major functions, namely delivery management 1102 and computation engine 1112. Delivery management 1102 handles the delivery agents' requirements of handing over the packages to all the customers in that run. Computation engine 1112 handles the backend intelligence to predict the right candidate from the TARN based on GPS, history, ground reality, trend, and other inputs.

Manual Delivery management 1104 manages the manual delivery agents 602 and their functioning. It resolves the state and federal laws in the jurisdiction of the delivery agent 602 before accepting a request for alternate recipient. It provides the initialization of manual delivery agents 602, their run for the day, reboot, and other debugging assistance to bring it to functional status. Drone management 1106 manages the drone delivery agents 604 and their functioning according to state and federal laws. It provides similar initiation function. In addition, it manages the data on fuel efficiency, network stabilization, routing table backups and specific issues related to the drone management. Candidate list update 1108 module interfaces with computing engine 1112 to obtain the proper candidate lists when requested by the delivery agents based on GPS. Delivery status update 1110 module receives information from all the delivery agents 602, 604 on their success and failures of deliveries. Delivery agents interface with delivery status update 1110 module to obtain the candidate list and delivery information.

Delivery scheduler 1114 module calculates the schedule of every delivery agent 602, 604 when initiated, and at any given time adaptively. It gathers from other modules, such as predictive models 1120 the candidate list, probable alternate recipient, next delivery path info. User history tracker 1116 closely monitors the gathered data from all the delivery agents on the customer availability and distribution of their alternate recipient choice. Analytics or Hysteresis 1118 engine provides analysis of timing (response, delivery, travel, etc.), location, behavior and other inputs of the alternate recipient TARN. The input contains a candidate list that can a customer is aware who can be used for alternate delivery. Without loss of generality, Hysteresis engine incorporates Analytics. In one embodiment, if the delivery agent is delivering in the afternoon, the customer might request the package to be delivered near his or her office. In another embodiment, if it is a weekend the customer might request it be delivered to the neighbor. In another embodiment, the customer might be comfortable leaving it with a neighbor or a relative. Predictive models module 1120 uses the information from the user history 1116 and Analytics in the engine 1118 to analyze the past behavior and present requirement to derive important metrics for optimizing the route, delivery agents, alternate recipient accuracy and loss of package. In one embodiment, fuzzy logic is used to calculate the probability of acceptance of alternate recipient. In another embodiment, intelligence methodology usage is not precluded to fuzzy logic but could vary from simple Boolean logic to quantum logic or deontic logic based on the inputs that are available and the logic that can be applied.

FIG. 12 illustrates the control and data flow from the delivery agents 602, 604 to the backend intelligence, namely adaptive intelligence module of intelligent trusted alternate recipient network design and methodology, 1008. The feedback loop and the dependence are shown in the flow. The proposed intelligent trusted alternate recipient network design and methodology uses the delivery agents provide GPS coordinates′, next customer delivery information and the authentication information to the adaptive intelligence module 1008. The backend intelligence calculates the trusted alternate recipient candidate list 1210, customer specific data 1212, alternate recipient TARN data 1216 and the delivery map 1214 and relays back to delivery agent 602, 604. In addition adaptive intelligence module 1008 updates the knowledgebase 508 for adaptive computation. FIG. 12 illustrates the proposed adaptive intelligence control system to accomplish the alternate trusted recipient network method. For the control system to operate, two closed loops are proposed. The delivery agent obtains the customer data list 1212 and the delivery map 1214 at the start of the run. Based on the next delivery requirement 602 604 the delivery agent updates the profiler 1206. Adaptive intelligence 1008 module uses analytics to calculate the alternate recipient candidates list 1210 for the customer and provides the input back to delivery agent. The second loop is to provide the best alternate candidate 1216 back to the delivery agent. This intelligence loop continues for every single customer that needs to be delivered, while the control system learns continuously based on the candidate ultimately chosen as alternate recipient, their GPS, place of residence, time and other authentication information 604.

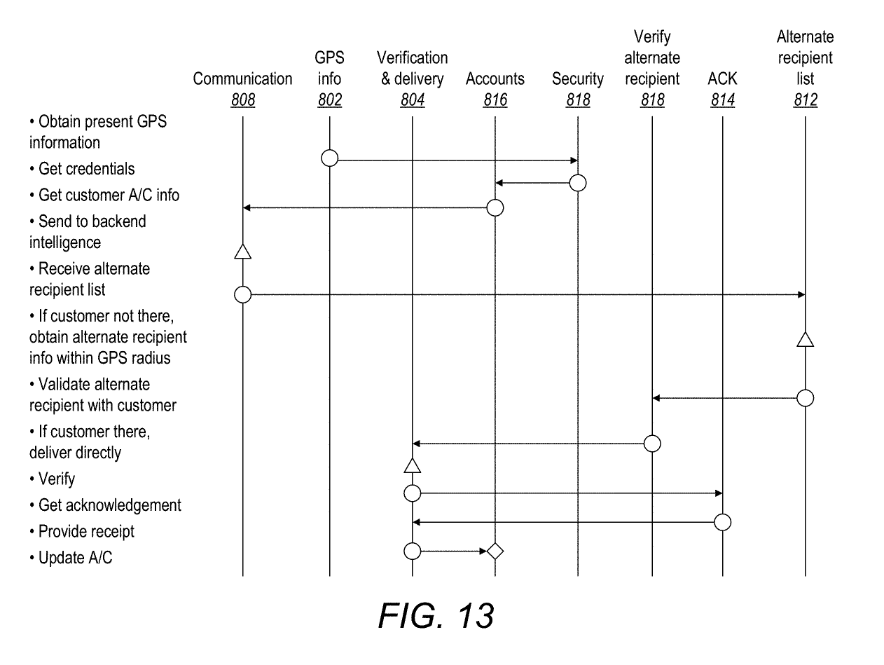

FIG. 13 illustrates the application controller of the intelligent trusted alternate recipient network design and methodology, 820 interactions for delivery mechanism. The message sequence diagram clearly relays the methodology for the interaction between delivery agent 602, 604 and the backend intelligence 1008 to get the candidate list. Once the customer is contacted, the message sequence for the interaction between delivery agent 602, 604 and the end customer is provided. The use case in FIG. 13 clearly enumerates the steps for delivering a package to a customer or an alternate recipient. The initial steps are to obtain the GPS information 802, credentials 818 for security, customer information 816 from accounts and send to backend adaptive intelligence through communication module 808. If the customer is available, then the package is delivered 804. If not, the alternate recipient 818 is picked and the delivery is completed. The delivery is verified and acknowledgement 814 received.

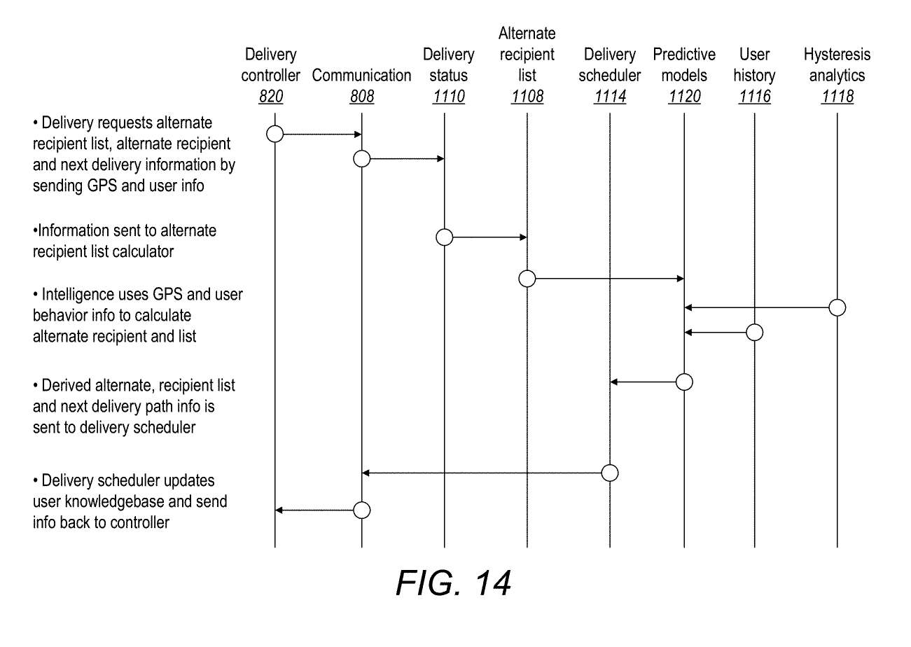

FIG. 14 illustrates the adaptive intelligence mechanism, showing the message sequence diagram for the interaction between the controller 820 and the intelligent TARN engine 506. Delivery agent provides GPS and user information, and obtains the candidate list, alternate recipient and next delivery information from the adaptive intelligence module 1008. The message sequence chart shows the interaction between various modules to achieve this. FIG. 14 clearly provides the use case from the adaptive intelligence control system point of view. The delivery agent requests alternate recipient list and the alternate recipient 820. The controller element calculates the alternate list 1120, 1116, 1118 and alternate recipient and communicates 808 through delivery scheduler 1114. The alternate recipient list and the alternate recipient is sent back to delivery controller 820.

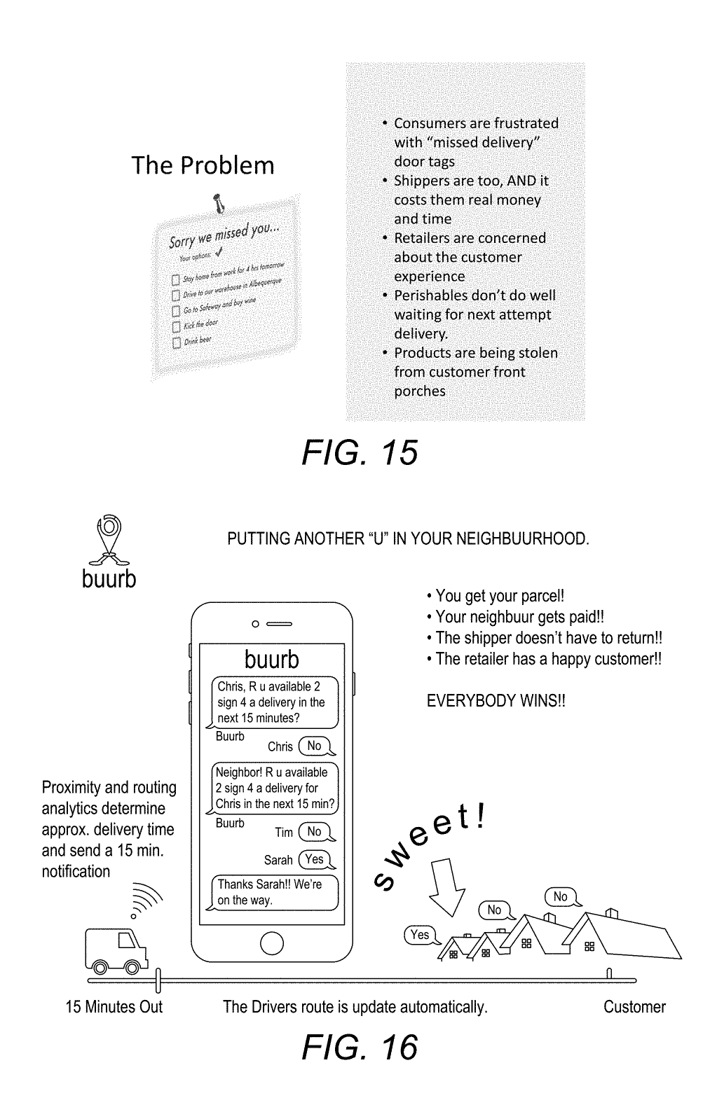

FIG. 15 shows the current state of affairs in delivery systems such as, consumers/user frustration with “missed delivery” door tags, shipper's aggravation with increased cost and time associated with failed delivery attempts, retailers' concern with the customer experience, perishability of goods and theft.

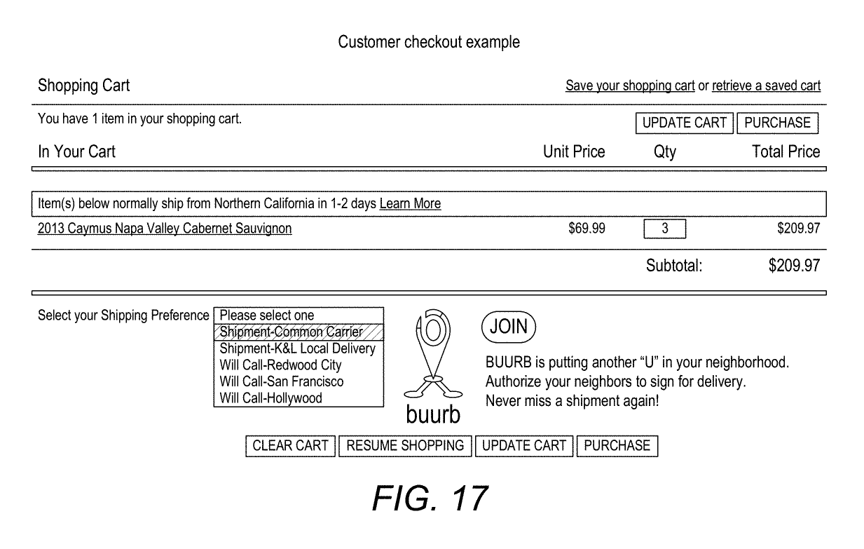

FIG. 16 shows the instant system, method and process on a mobile device. The user has set up a trusted network of neighbors to serve as backup for package delivery. When the user orders a product from a retailer, the proposed adaptive intelligence system is notified. The shipper confirms the delivery address through the application and continues to verify the delivery location as the shipment nears the destination. The intelligent trusted alternate recipient network design and methodology, maintains communication with the package recipient throughout to confirm their availability for receipt. If the recipient is unavailable at any time, proposed adaptive intelligence system sources a backup recipient from the user's TARN and notifies the shipper of the new address. Once the package is delivered, the proposed adaptive intelligence system confirms such with the customer and then connects the customer with their alternate delivery recipient to initiate pick-up arrangements. FIG. 17 shows a screen shot of the shopping cart displaying options for delivery.

### INDUSTRIAL APPLICABILITY

The instant system, method and process would reduce cost, improve the bottom line, reduce insurance expense, reduce carbon emissions from repeat deliveries, and eliminate loss of package delivery for delivery companies and users. The system, method and process implemented on a device also enables merchants to improve user satisfaction and utility from the merchant's products, add new customers through trusted neighbor networks, and empower captive marketplaces. The instant process, method and system also may also empower individuals spend large periods of time at home to become trusted neighbors for a user and potential package receipt agents for pre-approved merchants and delivery companies.

Backend intelligence would increase the accuracy and safety of the delivery during the first run to the satisfaction of the customers, while also reducing cost. The method is applicable in a general assignment and transportation problem. The method is applicable to any transportation company that requires intelligent routing. The backend intelligence is cloud based in one embodiment and in another embodiment be provided on premise and an Application Programming Interface (API) can be used for any third party transportation company to interface to the intelligence. The method can be used in various geographical regions. The method can be used as part of operations research and optimization package. The method is applicable for automation of human-based delivery and for transportation firms that use drones or other automation to deliver packages.

What is claimed is:

1. A system for delivery of a package using a trusted alternate recipient network used on a device, comprising:
an input module for a user to create a trusted alternate recipient list for delivery of the package on a personal device;
a collaboration module to receive a trusted recipient list from the user and to update a data to a back end intelligence system;
a delivery agent schedule module to use an intelligent trusted alternate recipient network to receive the trusted alternate recipient list for delivery of the package on a delivery device from a server module; and
a communication module to enables a delivery agent to deliver the package.

2. The system of claim 1, further comprising:
an analysis module to provide a location change to the device if there is a change in the trusted alternate recipient list.

3. The system of claim 1, wherein the delivery mode is at least one of a person, machine and combination thereof.

4. The system of claim 2, further comprising;
a recommendation module to provide an option for the user and a delivery company about a location for delivery of the package to optimize a quick delivery.

5. The system of claim 1, further comprising;
a delivery agent scheduler module to ensure the package is delivered to the user or a trusted alternate recipient.

6. A method of delivering a package using a trusted alternate recipient network, comprising;
creating a trusted alternate recipient list by a user for receiving a package on a device for a said time and day;
accepting to receive the package by a trusted alternate recipient;
updating the trusted alternate recipient list on a back end server for a delivery company in real time;
calculating an optimal route for the delivery company to deliver the package to the user or the trusted alternate recipient; and
delivering the package to a location of choice by the user.

7. The method of claim 6, further comprising;
using an unmanned or a manned delivery means for delivering the package to the location of choice by the user.

8. The method of claim 6, further comprising;
contacting the user using an intelligent trusted alternate recipient network through at least one of an SMS, text messaging, email, chat, VoIP, and other voice, video and data mechanism to suggest the candidate list and agree on an alternate available recipient where the package to be delivered.

9. The method of claim 6, further comprising;
picking a second alternate trusted recipient if the a first trusted alternate recipient is unavailable during delivery by the delivery company.

10. The method of claim 9, wherein the second alternate trusted recipient is confirmed by the user and the second alternate trusted recipient using the device.

11. The method of claim 11, further comprising:
an adaptive intelligence engine for adaptively calculating the alter gate recipient list for any customer to whom a delivery needs to be executed.

12. The method of claim 11, further comprising:
an adaptive alternative recipient list computed using predictive models, analytics and hysteresis based on information provided by delivery module and the user knowledgebase collected.

13. The method of claim 11, further comprising:
an adaptive control based on feedback from the delivery modules that include customer information such as location, GPS, packet information, time and route to intelligently input into predictive models, analytics and hysteresis.

14. The system of claim 1, further comprising:
a control system delivery agent for obtaining real-time customer information such as GPS, address, and authentication and providing input to a backend adaptive intelligence controller.

15. The system of claim 14, further comprising:
a control method delivery agent that receives feedback on alternate delivery recipient list and main candidate from the backend intelligence module to update the route map for next customer delivery.

16. The system of claim 13, further comprising:
an interface and method to collect user knowledgebase to be used as an input to predictive models for calculation of optimal route and optimal alternate recipient list for a customer in future.
